(19) United States
(12) Patent Application Publication
(10) Pub. No.: US 2022/0074598 A1
(43) Pub. Date: Mar. 10, 2022

(54) Temperature Control System for Cooking Appliances

(71) Applicant: NuWave, LLC, Vernon Hills, IL (US)

(72) Inventors: Jung S. Moon, Long Grove, IL (US); Jong Rok Kim, Seoul (KR)

(21) Appl. No.: 17/314,379

(22) Filed: May 7, 2021

Related U.S. Application Data
(60) Provisional application No. 63/075,995, filed on Sep. 9, 2020.

(51) Int. Cl. F24C 7/08; A47J 36/32; A23L 5/10; H05B 1/02

(52) U.S. Cl. CPC F24C 7/087; A47J 36/32; A23V 2002/00; H05B 1/0258; A23L 5/15

(57) ABSTRACT

A method for controlling a cooking temperature within a cooking appliance is described. The preferred method includes setting a desired cooking temperature (T) for the cooking appliance via a temperature setting input, and operating the heating element to raise an internal temperature within the cooking chamber based on a power input strategy. Preferably, the power input strategy includes selecting an initial power (PO) between 50% and 100% power, powering the heating element at the initial power using an on/off cycle of N milliseconds based on the formulas:

on time=(Pᵢ)·N milliseconds; and

off time=(100−Pᵢ)·N milliseconds;

then, reducing the initial power to a reduced power (Pᵣ) as the rising internal temperature within the cooking chamber approaches the desired cooking temperature, wherein the reduced power (Pᵣ) is between 1% and 99% power. Finally, the desired temperature is maintained within the cooking chamber.

### RELATED APPLICATION

The present application claims the filing priority date of U.S. Provisional Application No. 63/075,995 titled “Power Control Device” and filed on Sep. 9, 2020.

### TECHNICAL FIELD OF THE INVENTION

The present invention relates to cooking appliances. More specifically, the invention relates to a cooking appliance having a temperature control system to regulate cooking temperature more effectively.

### BACKGROUND OF THE INVENTION

Typically, a cooking appliance cooks at a set temperature by continually powering a heating element at a predetermined high-power level until a desired temperature is achieved. Predictably, this method overshoots the set temperature, requiring heating to be stopped (i.e., zero power) to allow the cooking chamber of the appliance to cool to the set temperature. Again, the target temperature is expectedly overshot, and powering of the heating element is once again commenced. The result of this widely used on/off power heating method is illustrated best in the temperature and power graphs of FIGS. 1-6. As is clearly shown, the target or set temperatures of the appliances in FIGS. 1, 3 and 5 are repeatedly passed by several degrees as the cooking appliance is either in a heating phase (power on) or a cooling phase (power off), as illustrated in the corresponding voltage graphs of FIGS. 2, 4 and 6.

In the comparative prior art system of FIGS. 1 and 2, the cooking chamber temperature consistently varies by as much as 40° F. during the less than 60-minute cooking period. The comparative prior art system of FIGS. 3 and 4 achieves the desired temperature but is then equally consistently varying the temperature well-below the set temperature by about 10° F. during the cooking period.

Better microprocessors have refined this procedure somewhat by extrapolating temperature points based on linear heating and cooling phases and more rapidly turning power on and off to the heating element before reaching the target or set temperature. The comparative prior art system of FIGS. 5 and 6 show a more consistent cooking temperature, varying the temperature around the set temperature by less than 10° F. The result of the more advanced microprocessor-controlled systems still results in a set temperature to be repeatedly passed as the cooking chamber temperature rises and falls during the cooking process.

Nonetheless, this continuous fluctuation of the cooking temperature, even of just a few degrees, can be problematic for the requirements of precise cooking and baking. A system or appliance capable of achieving and maintaining a more consistent cooking temperature is desired in the industry.

Prior systems and appliances have only attempted to control cooking temperature by turning power on and off based on internal cooking temperature readings. Accordingly, a new system, device and method is necessary to control the cooking temperature of a cooking appliance with greater precision.

Applicant has discovered a way to use a switching device (e.g., a TRIAC) for greater power control, and as a result temperature control, in electric cooking appliances. Until the invention of the present application, problems of accurate temperature control in the prior art went either unnoticed or unsolved by those skilled in the art. The present invention provides cooking systems capable of performing multiple cooking functions with the associated device without sacrificing portability features, designs, style or affordability.

### SUMMARY OF THE INVENTION

There is disclosed herein an improved method and system for controlling a cooking temperature in a cooking appliance which avoids the disadvantages of prior methods and systems while affording additional structural and operating advantages.

Generally speaking, such cooking appliances include a cooking chamber, a heating element for heating the cooking chamber, a temperature setting input, and a controller responsive to the temperature setting input and coupled to the heating element. An embodiment of the method for controlling a cooking temperature within a cooking appliance comprises setting a desired cooking temperature (T) for the cooking appliance via the temperature setting input, and operating the heating element to raise an internal temperature within the cooking chamber based on a power input strategy. Preferably, the power input strategy comprises selecting an initial power (Pᵢ) between 50% and 100% power, inclusive, based on the desired cooking temperature, powering the heating element at the initial power using control pulses having on and off times of N milliseconds based on the formulas:

on time=(Pᵢ)·N milliseconds; and

off time=(100−Pᵢ)·N milliseconds;

then, reducing the initial power to a reduced power (Pᵣ) as the rising internal temperature within the cooking chamber approaches the desired cooking temperature, wherein the reduced power (Pᵣ) is between 1% and 99% power. Finally, the desired temperature is maintained within the cooking chamber.

In specific embodiments, the method for controlling a cooking temperature within a cooking appliance further comprises adjusting the reduced power (Pᵣ) to an adjusted power (Pₐ) within the range of 1% to 100% power and maintaining the desired temperature comprises continually adjusting power within the range of 1% to 100% power.

In specific embodiments, the method for controlling a cooking temperature within a cooking appliance comprises determining a temperature change rate (ΔT) within the cooking chamber during operation and reducing the initial power (Pᵢ) comprises adjusting the power of the heating element based on the temperature change rate as the cooking chamber temperature approaches the desired cooking temperature.

In still other specific embodiments, the method for controlling a cooking temperature within a cooking appliance may further comprise periodically determining a temperature ratio of the desired cooking temperature (T) to an actual cooking chamber temperature (Tₐ) and adjusting the reduced power (Pᵣ) to an adjusted power (Pₐ) when the temperature ratio (T:Tₐ) is less than or greater than 1.

In still other specific embodiments, the method for controlling a cooking temperature within a cooking appliance comprises powering the heating element at the adjusted power (Pₐ) using on and off pulses of 8.33 milliseconds based on the formulas:

on time=(Pₐ)·8.33 milliseconds; and

off time=(100−Pₐ)·8.33 milliseconds.

The on time and off time in each pulse is preferably created by a TRIAC gate signal from an microcontroller unit (MCU).

In another embodiment, a method for controlling a cooking temperature within a cooking appliance comprises setting a desired cooking temperature (T) for the cooking appliance via the temperature setting input, operating the heating element to heat the cooking chamber based on a power input strategy, wherein the power input strategy comprises selecting an initial power (Pᵢ) between 10% and 100% power, inclusive, based on the desired cooking temperature, powering the heating element at the initial power (Pᵢ), determining a temperature change rate (ΔT) within the cooking chamber during operation, selecting an adjusted power (Pₐ) of the heating element to between 1% and 100% power, inclusive, based on the temperature change rate as the cooking chamber temperature varies from the desired cooking temperature, and powering the heating element at the adjusted power (Pₐ).

These and other aspects of the invention may be understood more readily from the following description and the appended drawings.

### BRIEF DESCRIPTION OF THE DRAWINGS

For the purpose of facilitating an understanding of the subject matter sought to be protected, there are illustrated in the accompanying drawings, embodiments thereof, from an inspection of which, when considered in connection with the following description, the subject matter sought to be protected, its construction and operation, and many of its advantages should be readily understood and appreciated.

FIG. 1 is a graph showing a temperature profile for a first comparative prior art system during an approximately one-hour period of heating;

FIG. 2 is a graph showing a voltage profile for the first comparative system of FIG. 1 during an approximately one-hour period of heating;

FIG. 3 is a graph showing a temperature profile for a second comparative prior art system during an approximately one-hour period of heating;

FIG. 4 is a graph showing a voltage profile for the second comparative system of FIG. 3 during an approximately one-hour period of heating;

FIG. 5 is a graph showing a temperature profile for a third comparative prior art system during an approximately one-hour period of heating;

FIG. 6 is a graph showing a voltage profile for the third comparative system of FIG. 5 during an approximately one-hour period of heating;

FIGS. 7A-7C are graphs of power level on/off heating strategies for prior art cooking control systems;

FIG. 8 is a graph showing a temperature profile of an embodiment of the presently disclosed system during an approximately one-hour period of heating;

FIG. 9 is a graph showing a voltage profile for an embodiment of the present system during an approximately one-hour period of heating;

FIG. 10 is an overlay of the temperature profile of FIG. 7 and the

FIG. 11A is a graph showing a pulse width (K) of 1.67 ms in a 120 pulse/sec duty cycle;

FIG. 11B is a graph showing a pulse width (K) of 10 ms in a 60 pulse/sec duty cycle;

FIGS. 12A-12E are a series of power graphs for an embodiment of the present system showing on/off cycles ( 1/60 sec) for 90% power (A), 75% power (B), 50% power (C), 20% power (D) and 0% power (E);

FIG. 13 is a flow chart for an embodiment of a disclosed method of the temperature control system;

FIG. 14 is a schematic of an embodiment of a control board and electronic circuitry divided into four quadrants (1-4);

FIG. 15 is the first quadrant of the control board of FIG. 14;

FIG. 16 is the second quadrant of the control board of FIG. 14;

FIG. 17 is the third quadrant of the control board of FIG. 14;

FIG. 18 is the fourth quadrant of the control board of FIG. 14;

FIG. 19 is a schematic wiring diagram of an embodiment of the disclosed temperature control system;

FIG. 20 is a graph showing temperature readings (° F.) and power usage (alternating current voltage) over an approximately 60-minute period for the disclosed temperature control system using a desired temperature of 150° F.

FIG. 21 is a graph showing temperature readings (° F.) and power usage (alternating current voltage) over an approximately 60-minute period for the disclosed temperature control system using a desired temperature of 200° F.;

FIG. 22 is a graph showing temperature readings (° F.) and power usage (alternating current voltage) over an approximately 60-minute period for the disclosed temperature control system using a desired temperature of 250° F.;

FIG. 23 is a graph showing temperature readings (° F.) and power usage (alternating current voltage) over an approximately 60-minute period for the disclosed temperature control system using a desired temperature of 300° F.;

FIG. 24 is a graph showing temperature readings (° F.) and power usage (alternating current voltage) over an approximately 60-minute period for the disclosed temperature control system using a desired temperature of 350° F.; and

FIG. 25 is a graph showing temperature readings (° F.) and power usage (alternating current voltage) over an approximately 60-minute period for the disclosed temperature control system using a desired temperature of 400° F.

### DETAILED DESCRIPTION OF THE INVENTION

While this invention is susceptible of embodiments in many different forms, there is shown in the drawings and will herein be described in detail at least one preferred embodiment of the invention with the understanding that the present disclosure is to be considered as an exemplification of the principles of the invention and is not intended to limit the broad aspect of the invention to any of the specific embodiments illustrated.

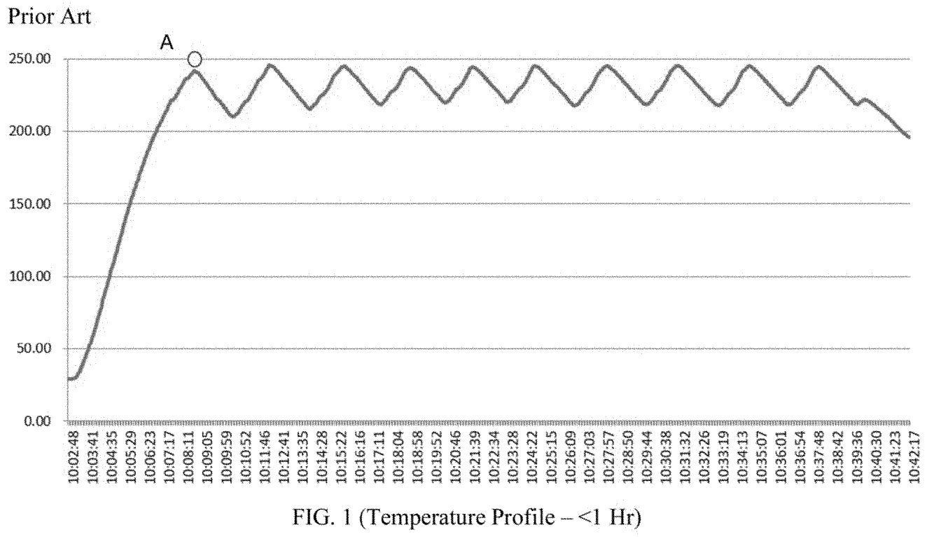

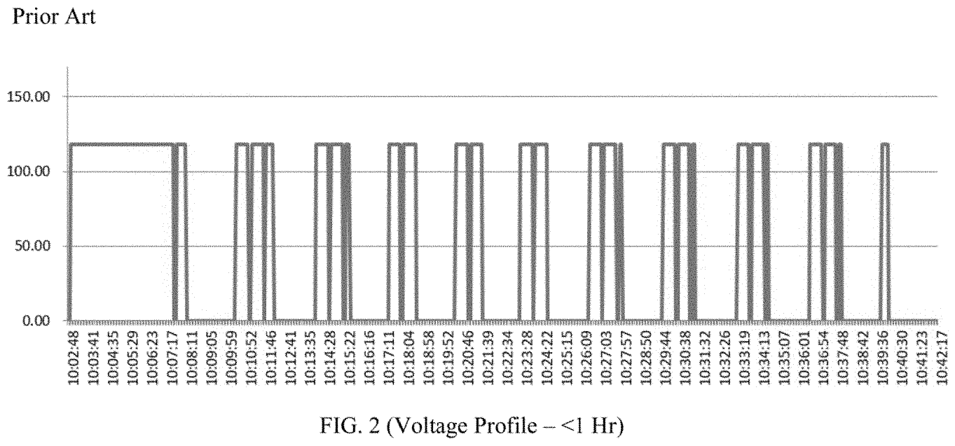

FIGS. 1-7 are directed to common prior art cooking systems and methods. In the first comparative example of FIG. 1, the system takes approximately five minutes to reach within 5 degrees of the target temperature of 250° (see point A). After reaching a peak of about 245° F., the system begins a continuous temperature bounce between about 245° and 210°, well short of the target temperature. The great heating variation is largely due to the repeated “on/off” cycling of the power, as illustrated in FIG. 2.

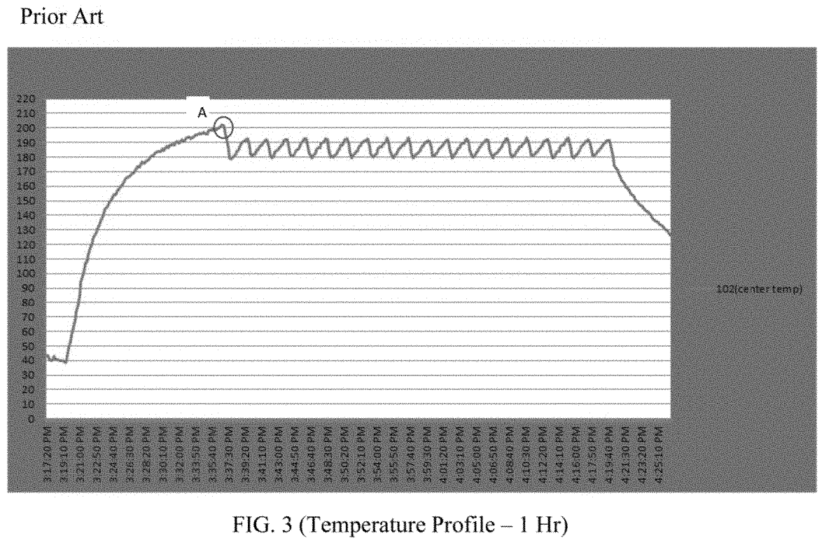

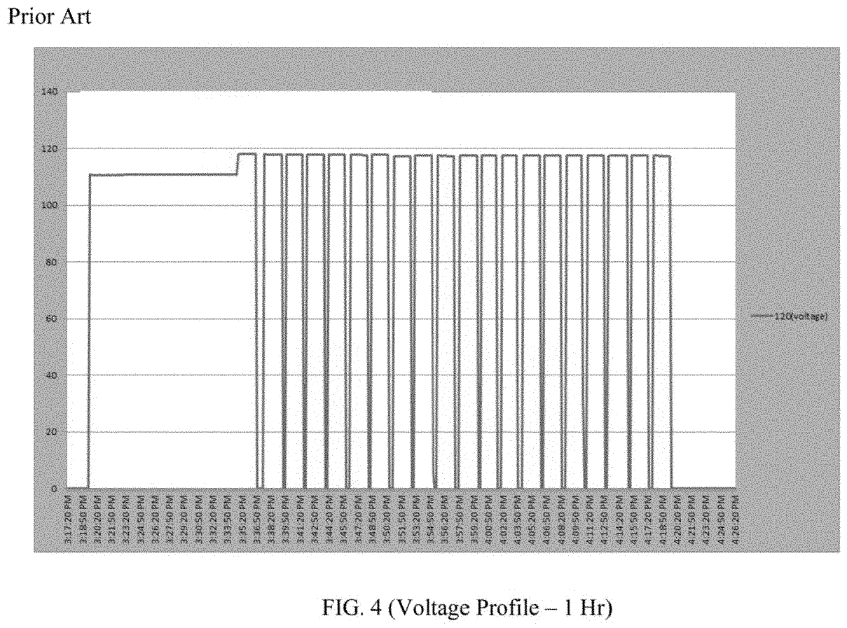

Referring now to the second comparative system of FIGS. 3 and 4, a similar heating strategy to that of the first comparative system is illustrated. The temperature profile of FIG. 3 illustrates an initial fluctuation of about 20° after reaching a desired cooking temperature (Point A) about 20 minutes into the one-hour heating period. The system then experiences a continuous temperature bounce of at least 10° rising and falling in the 180-190° range for the duration of the cooking time. The voltage profile of FIG. 4 shows 20 power drops to zero during the one-hour period corresponding to the temperature fluctuations.

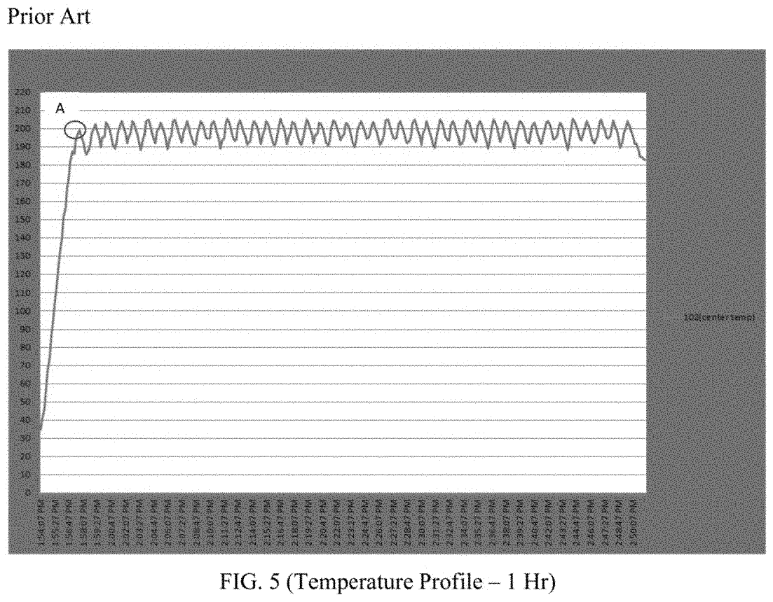

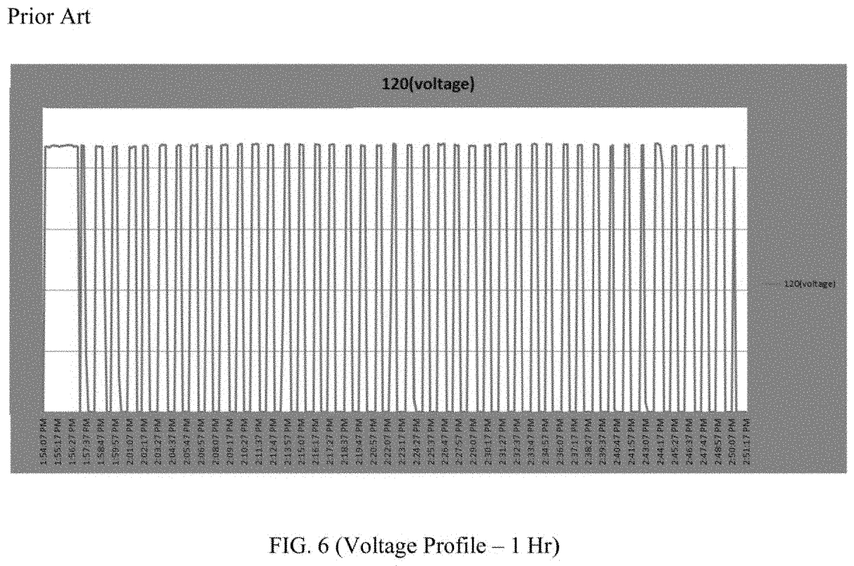

The system of FIGS. 5 and 6 achieves the target temperature (see point A) and manages to remain within about 2-10° of that temperature through peaks and troughs. However, the system of FIG. 5 experiences the temperature “bounce” at least 40 times in an hour. The temperature variation is the result of a heating strategy comprised of turning power to the appliance heating element off, as it reaches the target temperature, and on, as it drops below the target temperature. This strategy is best exemplified in FIG. 6, showing a voltage profile of the system of FIG. 5 during the same one-hour period. The graph of FIG. 6 shows power being turned on and off 44 times during the approximate one-hour period.

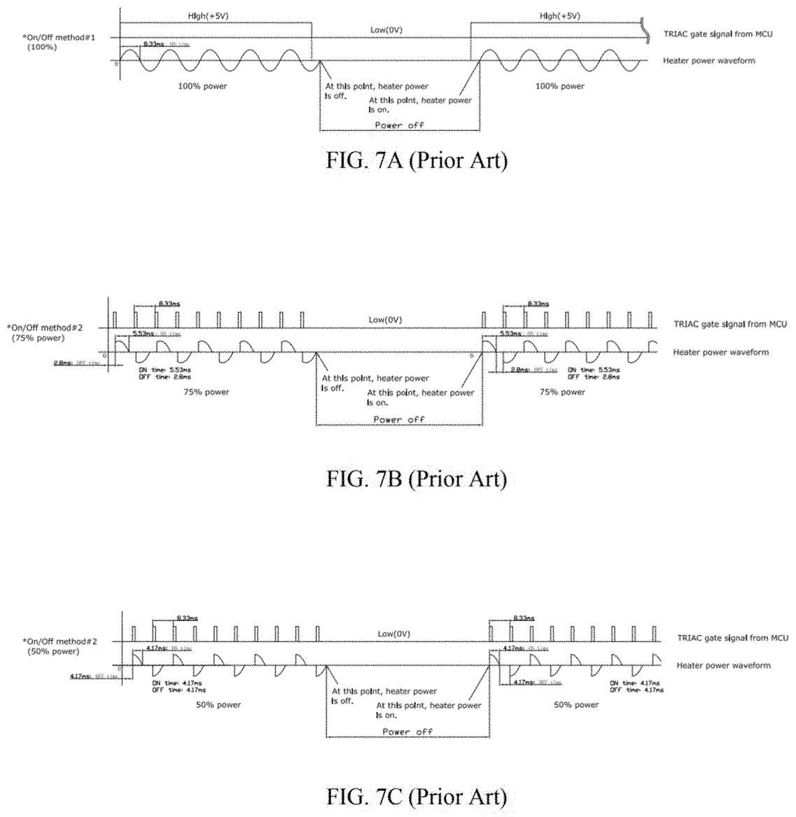

Finally, as shown in FIGS. 7A-7C, prior art systems which use TRIAC operate in a manner which results in periods of zero power—i.e., power off. This occurs at all power levels, including 50%, 75% and even 100% power, as shown by the graphs. The power control strategy of such cooking systems results in highly inaccurate and inconsistent temperature control as illustrated in the prior art temperature graphs.

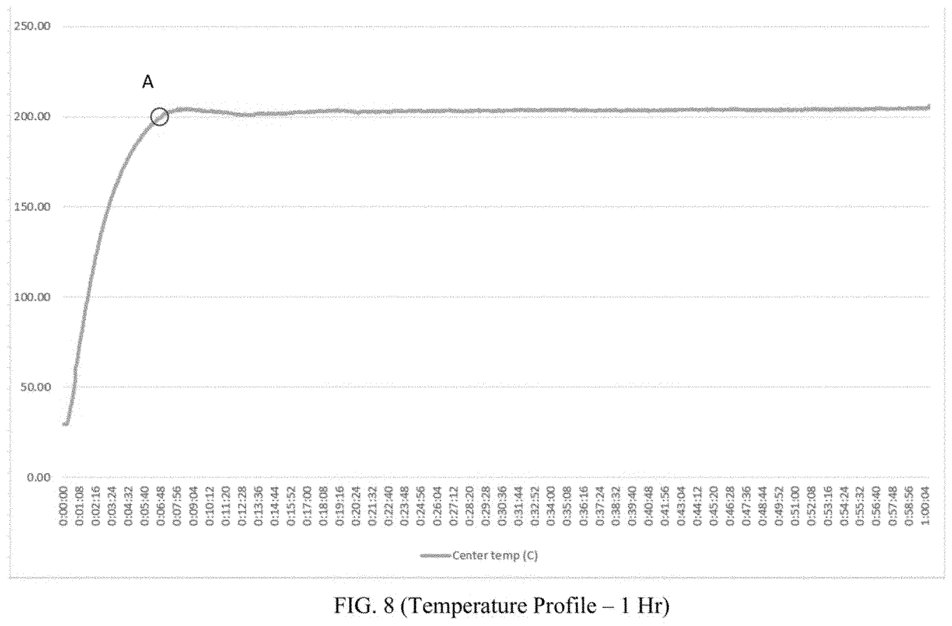

In contrast, with reference to FIGS. 8-10, the system and method of the present disclosure maintains the desired temperature more consistently over the cooking period than the prior art devices. The disclosed system achieves minimal temperature fluctuation as a result of power variations which occur without resorting to 0% power.

FIG. 8 shows a temperature profile over an approximately 60-minute period for an embodiment of the disclosed system with a target temperature of 200° F. The graph shows achievement of a desired cooking temperature (point A) followed by a mild temperature fluctuation of about 2-4° F. for the remainder of the one-hour period. The temperature profile lacks the obvious “bounce” illustrated for the comparative systems of FIGS. 1-6, and the degree of deviation from the target temperature is considerably less. The result is a far more steady and consistent cooking temperature.

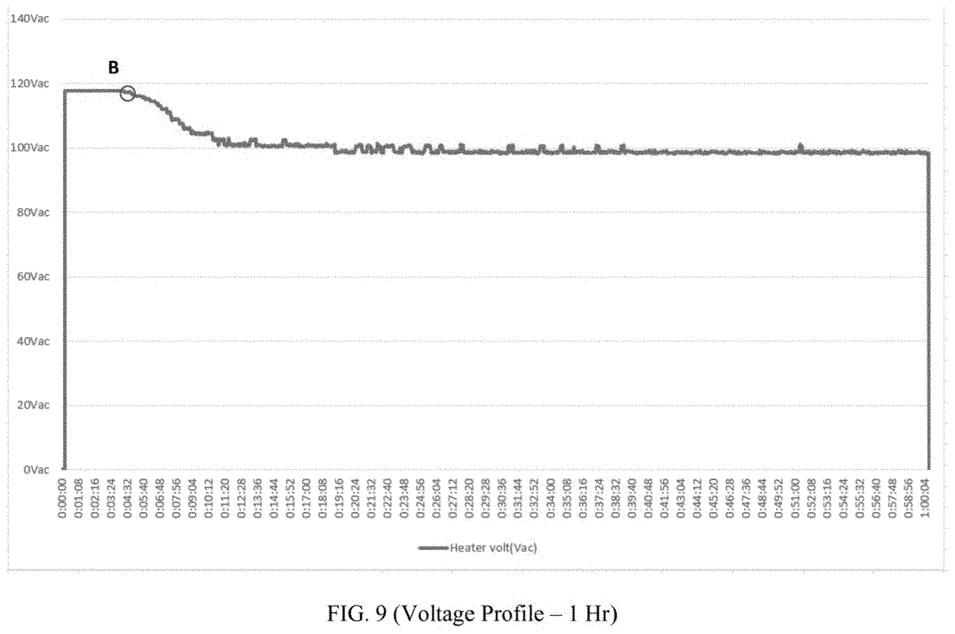

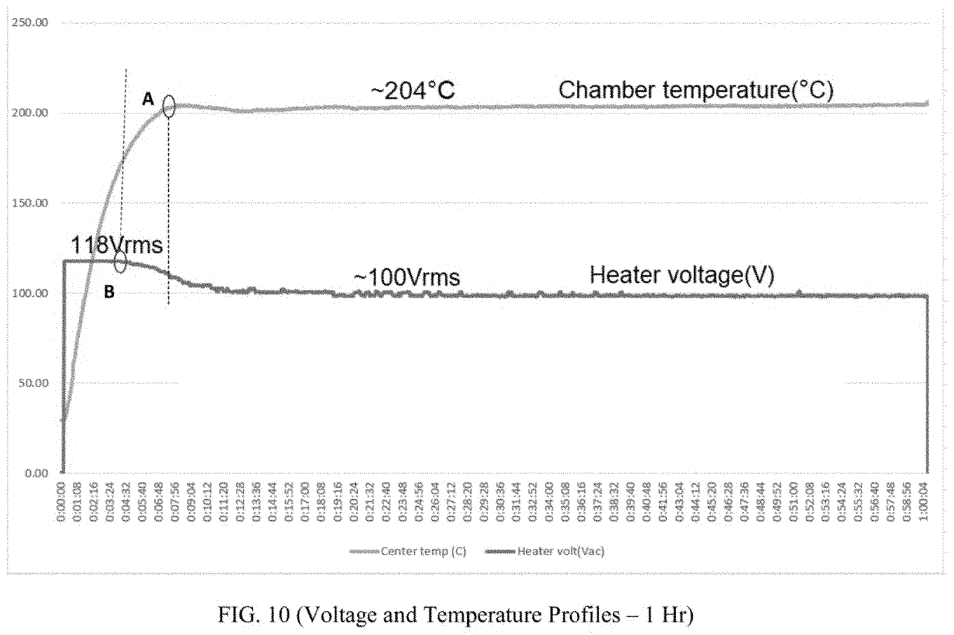

As shown in FIG. 9, the system of the present invention uses controlled non-zero voltage during the one-hour cooking period. The resulting voltage profile for the present system is more consistent than the prior art systems. Further, as best illustrated in FIG. 10, showing the overlay of the temperature and voltage profiles, the reduced, non-zero voltage corresponds to an even, consistent cooking temperature.

The ability of the system to reach lower power percentages is dictated by the pulse width (p-measured in time (microseconds)) of the TRIAC gate signal and the duty cycle—i.e., pulses per second. The pulse width (p) must follow the formula 0<p<K, where K is a value of the maximum pulse width (or duration) necessary to achieve a desired minimum linear power percentage. For example, a maximum pulse width (K) of 1.67 ms at 120 pulses/sec is needed to achieve a minimum linear power of 20% power. If the pulse width (p) is more than K(1.67 ms), 20% power cannot be achieved. A pulse duration of greater than 1.67 ms would exceed the “on-time” of any power setting below 20% in this example. However, at a duty cycle of 60 pulses/second the minimum achievable power would be 10%. When the pulse train applied to the TRIAC gate has a pulse width is less than 1.67 ms, at 120 pulses/sec, power settings from 10% to 100% can be achieved.

Referring back to the prior art power graphs of FIGS. 7A-7C, it can be seen that an AC power waveform has 2 regions, i.e., a (+) region and a (−) region, and they are repeated continuously. If a TRIAC gate signal is applied once during a (+) region, it is effective only at the (+) region, while the (−) region is ignored and removed. In order to achieve the maximum power by TRIAC phase control, the TRIAC gate trigger signal should be applied twice, once during each of the (+) region and (−) region, respectively. The result is 120 pulse/second applied by the TRIAC gate.

The temperature control for the present invention is significantly different than the prior art of FIGS. 1-7. An illustrative example is shown in FIGS. 8-10, where cooking temperature and system power levels are charted for a one-hour cooking period. At approximately the 5:40 mark of FIG. 8, the cooking temperature reaches a target temperature of 200° F. (point A) and begins to level-off. The duration of the cooking period the temperature remains consistent—i.e., a straight horizontal line.

The voltage graph of FIG. 9 illustrates the power level during the one-hour cooking period. FIG. 9 clearly shows that the voltage is never at zero power. As the temperature quickly rises to the target temperature (FIG. 8), the voltage is at substantially full power. However, at approximately the 3:40 mark of FIG. 9 (Point B), the voltage begins to decrease until it levels off at approximately the 10:12 mark.

As shown best in FIG. 10, which is the temperature profile of FIG. 8 and the voltage profile of FIG. 9, the voltage decrease occurs before the temperature reaches the target temperature (Points A and B, respectively). This is due to the ability of the disclosed temperature control system to adjust the power level in response to feedback from sensors which determine a rate of temperature change (ΔT) and a ratio of actual temperature (T_{A}) to target temperature (T_{T}), as explained further below.

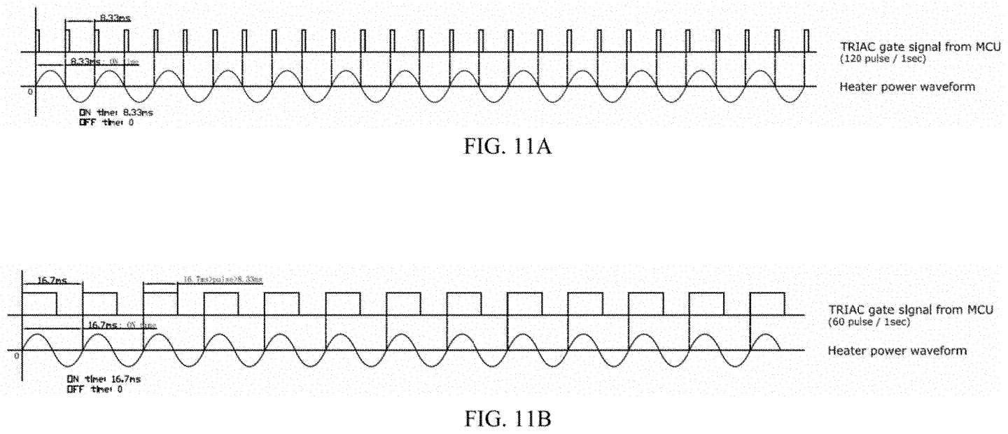

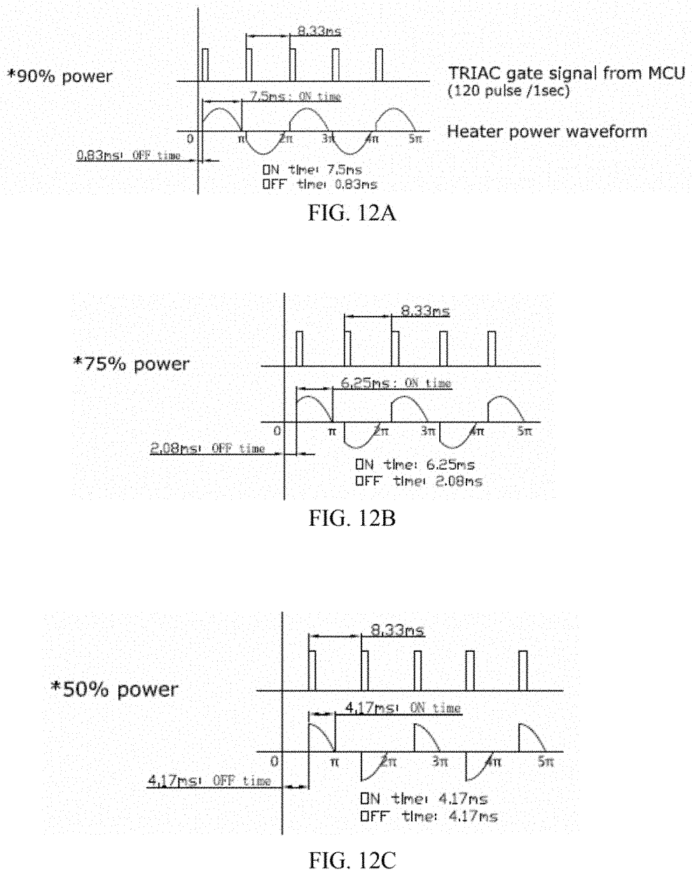

FIGS. 11A and 11B illustrate two operational alternatives for the TRIAC gate signal from a Master Control Unit (MCU): 120 pulses/second and 60 pulses/second. Once a minimum power is selected for a cooking operation (e.g., 10% power), then a pulse width (p) can be determined. For example, where the minimum power (K) to be used is 20%, the pulse width (p) is approximately 1.67 ms and the duty cycle is 120 pulses/second. Preferably, the TRIAC gate signal for the present system operates at 120 pulses/second.

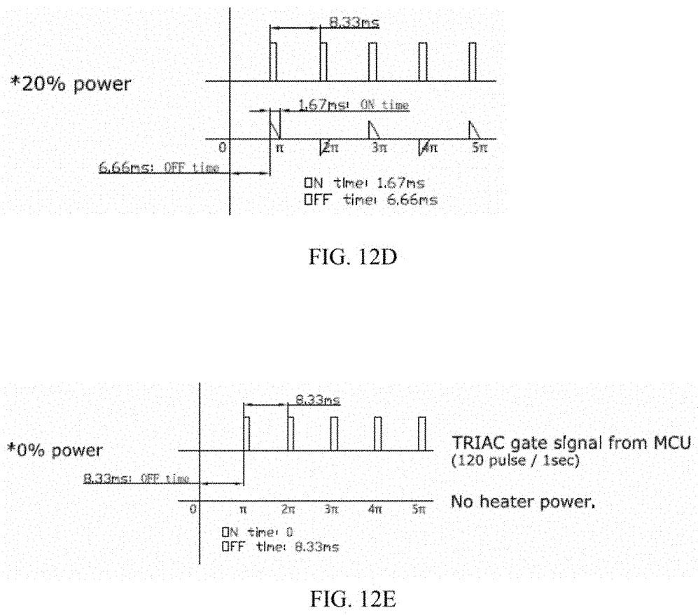

Referring now to FIGS. 12A-12E, the “on” and “off” periods and the corresponding gate signal at four different power levels, as well as 0% power, are illustrated. At 90% power (FIG. 12A) the system total “ON TIME” for each cycle may be calculated by the formula P·16.7 ms, which equals 15.03 ms (note: the numbers used are frequently rounded to two decimal places which may cause errors in accompanying graphs and calculations). Therefore, the total “OFF TIME” for each cycle is 1.67 ms.

At 75% power (FIG. 12B) the system total “ON TIME” for each cycle is 12.5 ms, while the total “OFF TIME” is 4.16 ms. At 50% power (FIG. 12C) the system total “ON TIME” and total “OFF TIME” for each cycle is 8.35 ms. Finally, at 20% power (FIG. 12D) the system total “ON TIME” is 3.34 ms, while the total “OFF TIME” is 13.36 ms. Of course, at 0% power (FIG. 12E) the “OFF TIME” is 16.7 ms for each full cycle.

The particular described method is for an electric convection oven (not shown). However, while the embodiment described is directed to a convection oven, it should be understood that the principles of the invention can be more broadly applied to almost any electric cooking appliance.

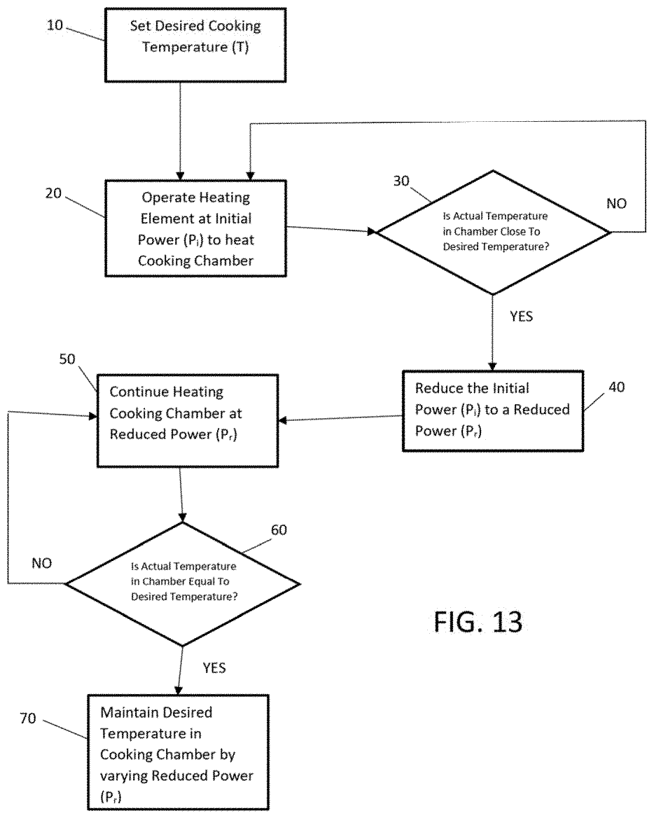

With reference to the flow chart of FIG. 13, the present cooking system and method can be more easily understood. A user begins by first setting a desired cooking temperature (T) using an interface, such as a touchscreen or button panel, and starts the cooking process (Box 10). The cooking temperature may also be determined automatically by selection of a pre-set cooking option—e.g., roast chicken, steamed veggies, etc. The cooking appliance, via a processor, determines an initial power (Pᵢ) at which to heat the cooking chamber of the cooking appliance (Box 20). Sensors monitor the actual temperature (T_{A}) within the cooking chamber and a processor compares this temperature to the desired temperature (Box 30). The processor determines if the two temperatures are close enough to begin reducing the initial power (Pᵢ) to a reduced power (Pᵣ) to slow the rising actual temperature (Box 40). The change of temperature over time (ΔT) may also be computed and used to determine whether a reduced or increased power is warranted. For example, where the rate of change is too steep during heating (i.e., rising too fast), e.g., at or more than 10°/min may be a threshold, the power may begin to decrease to slow the temperature rise. Conversely, when the rate of change is below a threshold (i.e., too slow), e.g., 2°/min or 5°/min, the power may begin to increase. This also applies where the temperature is falling, except that a rapid decrease (e.g., 10°/min) will trigger a power increase, and too slow a decrease (e.g., less than 2°/min) may trigger a further power decrease. These events may be tied to the temperature sensors and depend on actual vs. desired temperature. In a preferred embodiment, when the actual temperature is within about 10% to as much as about 30% of the desired temperature, the power may be adjusted. If not, the heating element of the cooking appliance will continue to operate at the initial power (return to Box 20). All of these threshold parameters may be different for different cooking appliances, cooking methods, food items, and other relevant cooking factors.

The system will continue to operate at the reduce power (Box 50). However, once the processor determines that the power is to be reduced (Box 40), the processor will continue to monitor and compare the actual temperature and desired temperature to further adjust the power (Box 60), as necessary. Once the processor determines that the actual temperature and desired temperature are equal, the processor will continue to maintain the cooking chamber at the desired temperature by varying the reduced power (Box 70), as necessary.

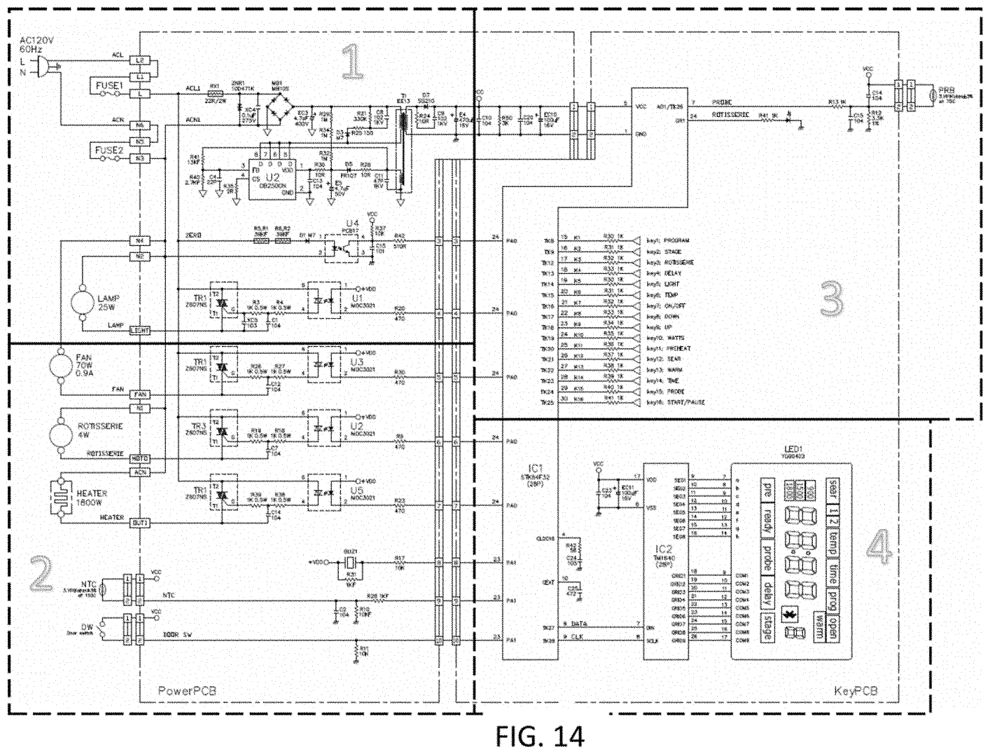

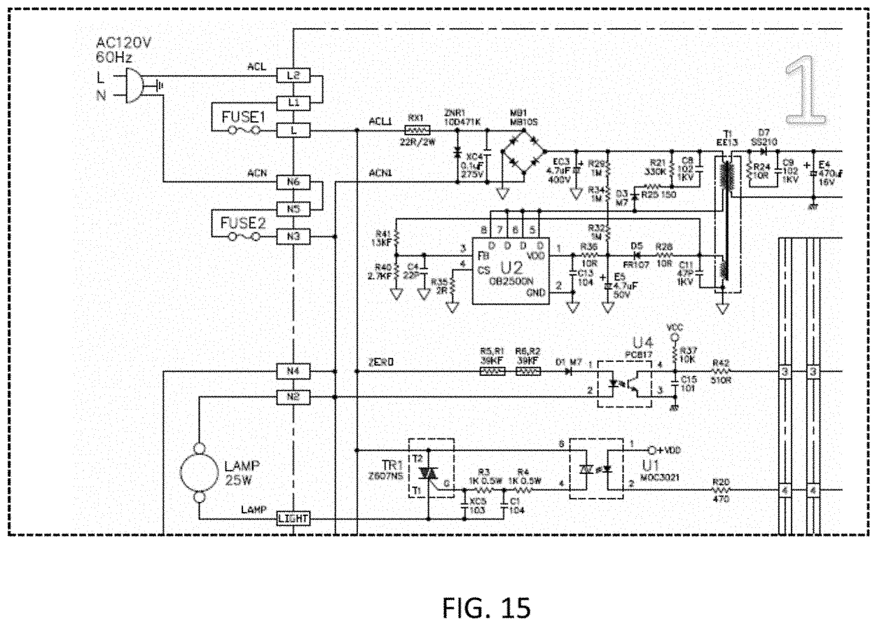

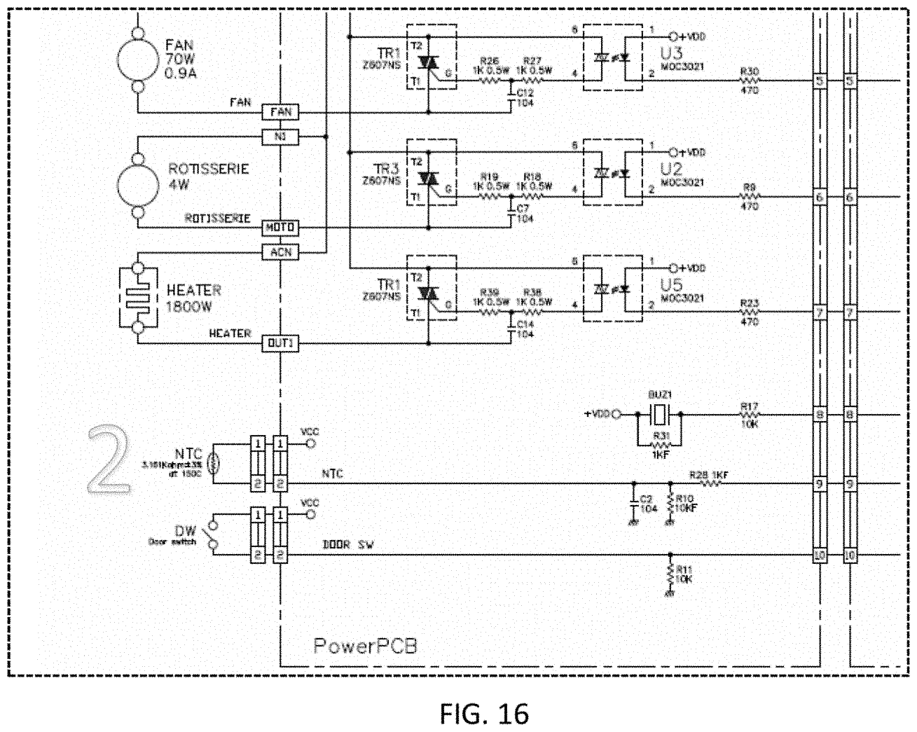

With reference to FIGS. 14-18, the electronics of the present temperature control system are illustrated. FIG. 14 is a master schematic for a specific embodiment of the system and is divided into four quadrants (1-4), as shown. The four quadrants are individually reproduced as FIGS. 15-18. Those skilled in the art will understand the features, capabilities and operation of the invention based on the schematics of FIGS. 14-18.

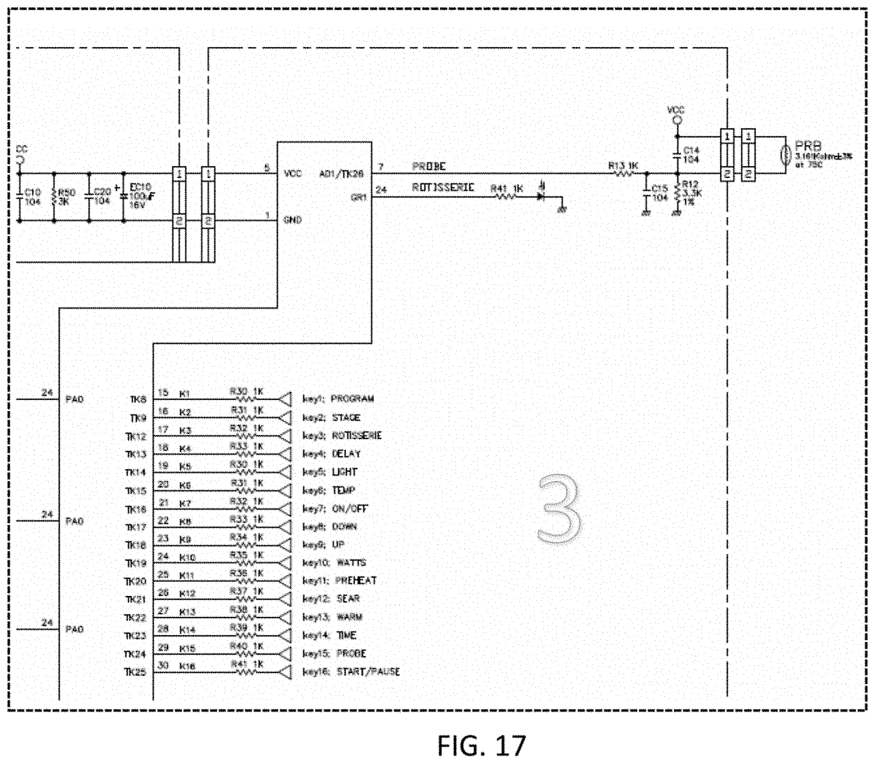

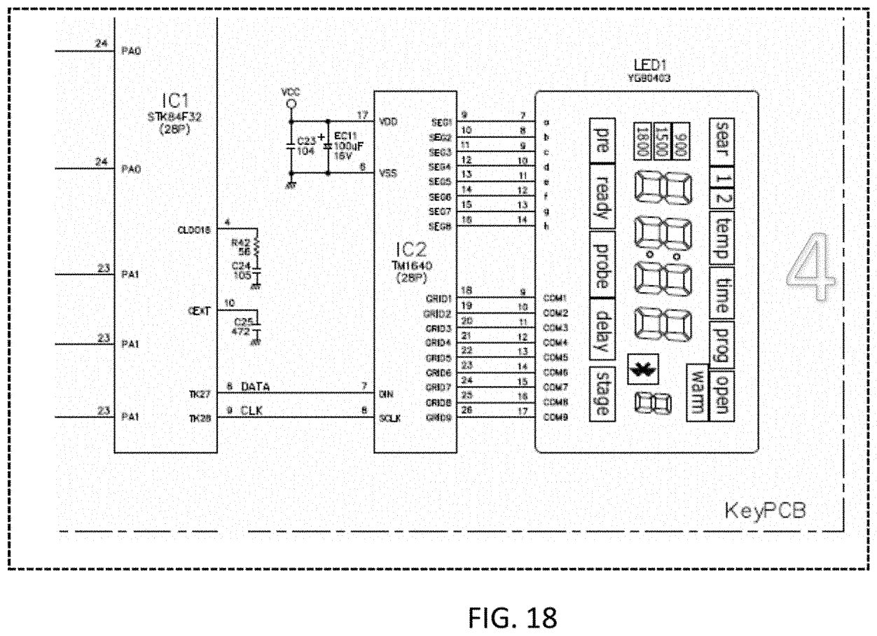

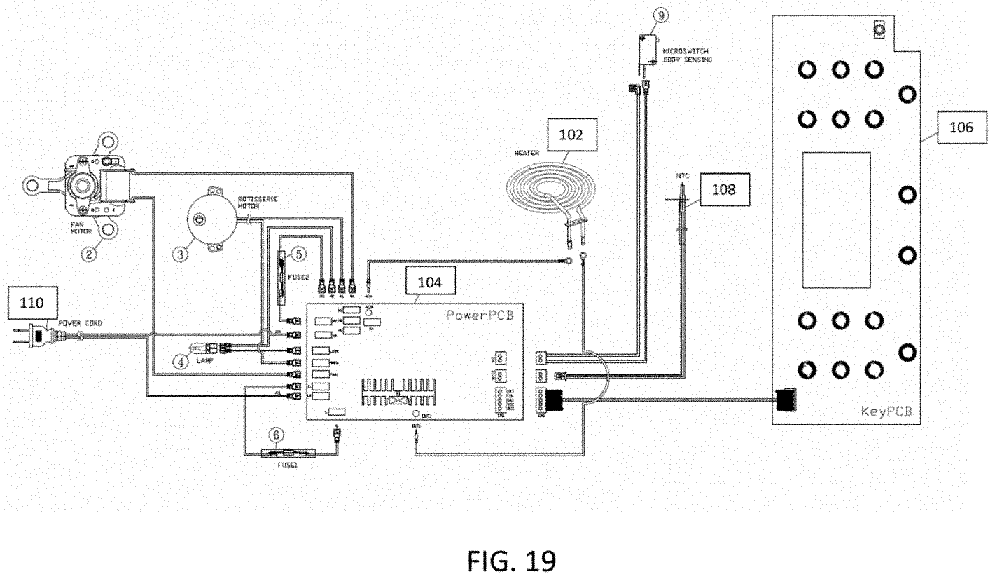

FIG. 19 is another schematic showing the wiring details of a preferred embodiment of the disclosed cooking appliance with the temperature control system. The schematic shows, among other components, heater 102, power PCB 104 (see FIGS. 15-17), input/key PCB 106 (see FIGS. 17-18), negative-temperature coefficient (NTC) thermistor 108, and AC power cord 110.

In preferred embodiments of the disclosed system, methods for controlling the cooking temperature within a cooking appliance are also considered unique. Generally speaking, the cooking appliance comprising a cooking chamber, a heating element for heating the cooking chamber, a temperature input, and a controller responsive to the temperature input and coupled to the heating element.

A preferred method begins with setting a desired cooking temperature (T) for the cooking appliance via the temperature input. Some cooking appliances may include preset cooking programs for specific meals or cooking methods—e.g., roast, air fryer, dehydrate, broil, toast, pizza, defrost, reheat, etc.—which include temperature settings as part of the preset program. Selection of such programs would be considered the equivalent of setting a cooking temperature for the appliance.

Once a temperature is set, operating the heating element raises an internal temperature within the cooking chamber based on a power input strategy. An aspect of the preferred method is that operational power to the heating element does not go to 0% power (e.g., 0 Watts) during the cooking process. Accordingly, a preferred power input strategy comprises selecting an initial power (Pᵢ) between 50% and 100% power, inclusive, based on the desired cooking temperature. In many instances, the initial power is likely to be at or near 100%. The system powers the heating element at the initial power using an on/off cycle of N milliseconds based on the formulas:

on time=(Pᵢ)·N milliseconds; and

off time=(100−Pᵢ)·N milliseconds.

In a preferred embodiment, N=16.7 so that each on/off cycle is 16.7 milliseconds at a TRIAC gate signal duty cycle of 60 pulses/second. Alternatively, N=8.33 where the on/off cycle is 8.33 milliseconds at a TRIAC gate signal duty cycle of 120 pulses/second. As shown in the accompanying charts, each on/off cycle is then comprised of two “ON” periods and two “OFF” periods.

As the temperature in the cooking chamber approaches the desired (or set) temperature, the initial power (Pᵢ) is decreased to a new reduced power (Pᵣ) to help prevent overshooting the desired temperature. Preferably, the reduced power (Pᵣ) is between 1% and 99% power. The reduced power may be reduced even further as the temperature within the cooking chamber approaches the desired temperature. The desired temperature is then maintained for the duration of the cooking process.

However, in some embodiments the power input to the cooking appliance may need to be adjusted. Adjustment of the cooking power may be an increase or decrease in power. Preferably, adjusting the reduced power (Pᵣ) to an adjusted power (Pₐ) falls within the range of 1% to 100% power. Adjusting the power is preferably done continually during the cooking process once the desired (or set) temperature is achieved.

In preferred embodiments of the method for controlling a cooking temperature within a cooking appliance, sensors are used to determine a temperature change rate (ΔT) within the cooking chamber during operation. That is, by periodically sensing the chamber temperature, a rate at which the temperature is increasing or decreasing (e.g., degrees/minute) can be determined. From this information, the disclosed system is capable of determining when to implement a reduced power (Pᵣ) and an adjusted power (Pₐ) to the cooking process.

In addition to the temperature change rate (ΔT), embodiments of the method may also or alternatively determine a temperature ratio of the desired cooking temperature (T) to an actual cooking chamber temperature (Tₐ). When the temperature ratio (T:Tₐ) is less than or greater than 1, the power is adjusted to increase or decrease the actual temperature. For example, the power will be adjusted lower when the temperature ratio (T:Tₐ) is greater than 1 and adjusted higher when the temperature ratio is less than 1. Preferably, this adjusting of the reduced power is done automatically.

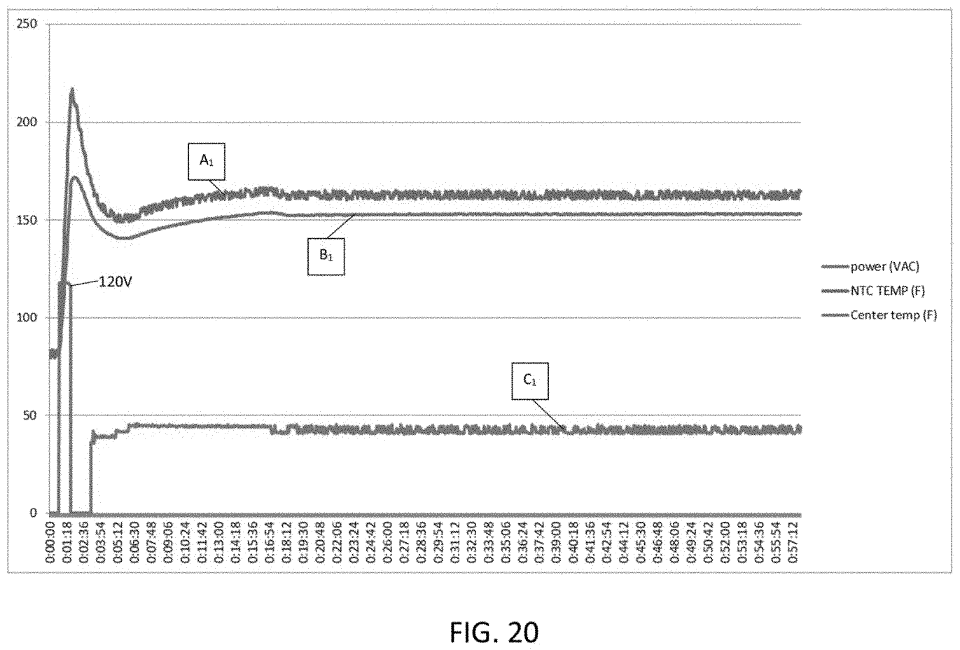

FIGS. 20-25 include numerous temperature/power graphs at specific desired temperatures for preferred embodiments of the disclosed system. For example, FIG. 20 illustrates a temperature profile with a desired temperature of 150° F. as well as the voltage (VAC) during the approximate one-hour heating period. The top line (A₁) indicates the temperature sensed at the NTC thermistor, while the middle line (B₁) shows the actual cooking chamber temperature. The bottom line (C₁) is the voltage (VAC) in use for the system (120V/1800 W).

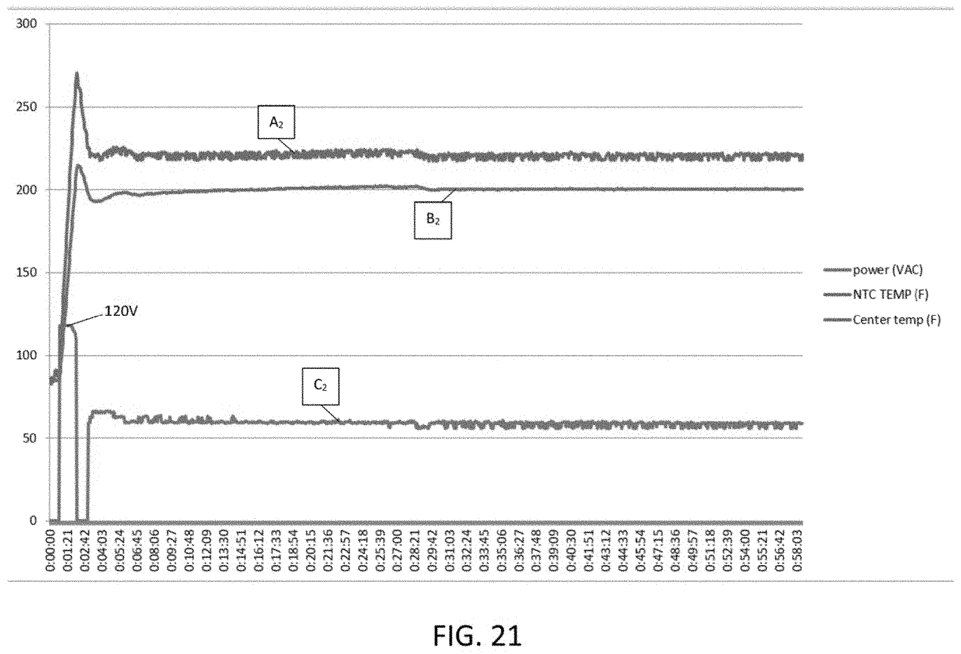

FIG. 21 illustrates a temperature profile with a desired temperature of 200° F. as well as the voltage (VAC) during the approximate one-hour heating period. The top line (A₂) indicates the temperature sensed at the NTC thermistor, while the middle line (B₂) shows the actual cooking chamber temperature. The bottom line (C₂) is the voltage (VAC) in use for the system (120V/1800 W).

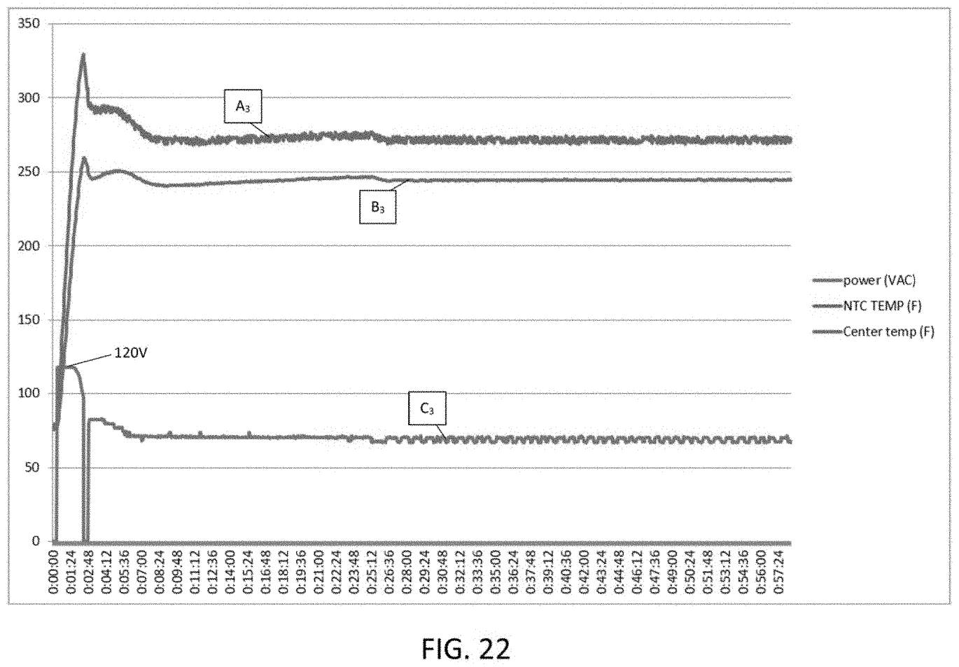

FIG. 22 illustrates a temperature profile with a desired temperature of 250° F. as well as the voltage (VAC) during the approximate one-hour heating period. The top line (A₃) indicates the temperature sensed at the NTC thermistor, while the middle line (B₃) shows the actual cooking chamber temperature. The bottom line (C₃) is the voltage (VAC) in use for the system (120V/1800 W).

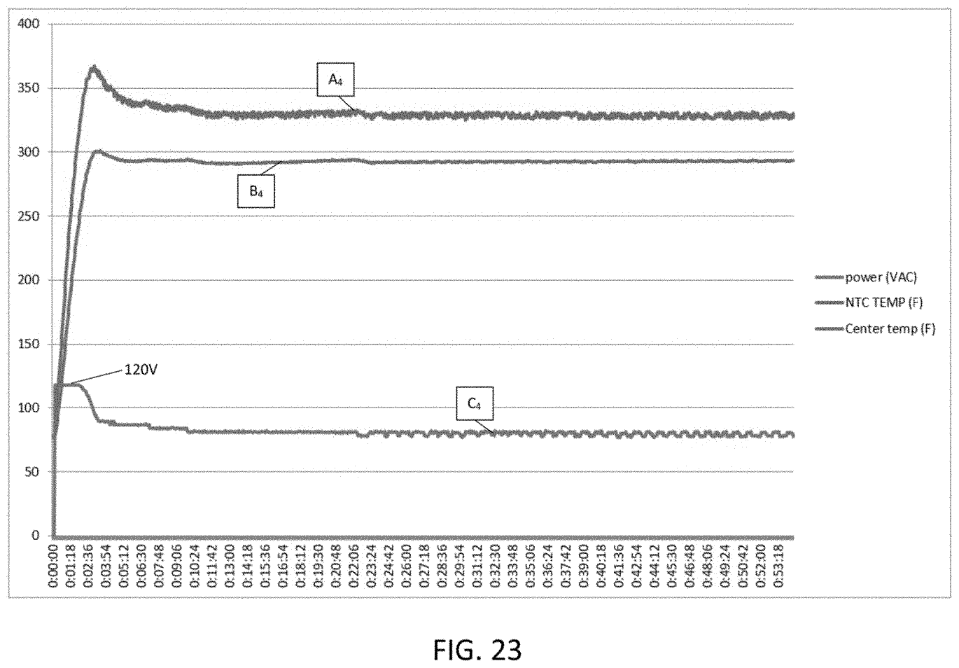

FIG. 23 illustrates a temperature profile with a desired temperature of 300° F. as well as the voltage (VAC) during the approximate one-hour heating period. The top line (A₄) indicates the temperature sensed at the NTC thermistor, while the middle line (B₄) shows the actual cooking chamber temperature. The bottom line (C₄) is the voltage (VAC) in use for the system (120V/1800 W).

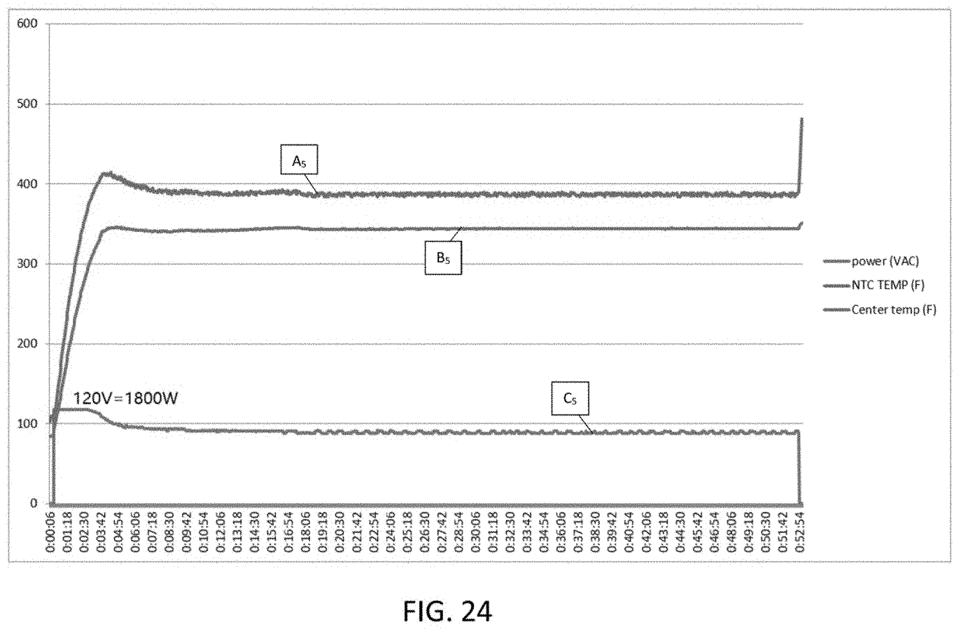

FIG. 24 illustrates a temperature profile with a desired temperature of 350° F. as well as the voltage (VAC) during the approximate one-hour heating period. The top line (A₅) indicates the temperature sensed at the NTC thermistor, while the middle line (B₅) shows the actual cooking chamber temperature. The bottom line (C₅) is the voltage (VAC) in use for the system (120V/1800 W).

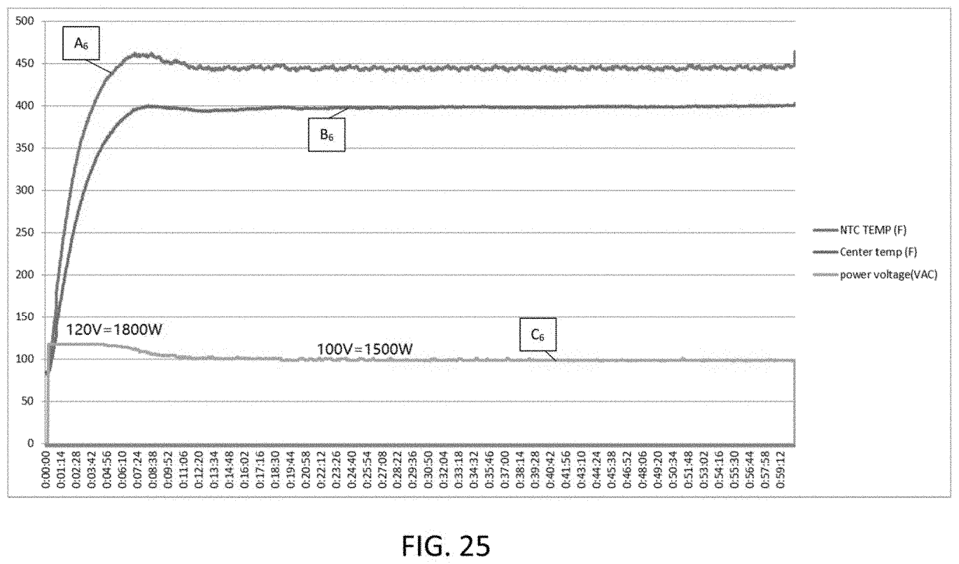

FIG. 25 illustrates a temperature profile with a desired temperature of 400° F. as well as the voltage (VAC) during the approximate one-hour heating period. The top line (A₆) indicates the temperature sensed at the NTC thermistor, while the middle line (B₆) shows the actual cooking chamber temperature. The bottom line (C₆) is the voltage (VAC) in use for the system (120V/1800 W).

The matter set forth in the foregoing description and accompanying drawings is offered by way of illustration only and not as a limitation. While particular embodiments have been shown and described, it will be apparent to those skilled in the art that changes and modifications may be made without departing from the broader aspects of applicants' contribution. The actual scope of the protection sought is intended to be defined in the following claims when viewed in their proper perspective based on the prior art.

What is claimed is:

1. A method for controlling a cooking temperature within a cooking appliance, the cooking appliance comprising a cooking chamber, a heating element for heating the cooking chamber, a temperature setting input, and a controller responsive to the temperature setting input and coupled to the heating element, the method comprising:
setting a desired cooking temperature (T) for the cooking appliance via the temperature setting input;
operating the heating element to raise an internal temperature within the cooking chamber based on a power input strategy;
wherein the power input strategy comprises:
selecting an initial power (Pᵢ) between 10% and 100% power, inclusive, based on the desired cooking temperature;
powering the heating element at the initial power;
reducing the initial power to a reduced power (Pᵣ) as the rising internal temperature within the cooking chamber approaches the desired cooking temperature, wherein the reduced power (Pᵣ) is between 1% and 99% power;
maintaining the desired temperature within the cooking chamber.

2. The method for controlling a cooking temperature within a cooking appliance, as set forth in claim 1, wherein the initial power is reduced when the internal temperature is within 10% to 30% of desired cooking temperature.

3. The method for controlling a cooking temperature within a cooking appliance, as set forth claim 1, further comprising adjusting the reduced power (Pᵣ) to an adjusted power (Pₐ) within the range of 1% to 100% power.

4. The method for controlling a cooking temperature within a cooking appliance, as set forth in claim 1, wherein maintaining the desired temperature comprises continually adjusting power within the range of 1% to 100% power.

5. The method for controlling a cooking temperature within a cooking appliance, as set forth in claim 1, further comprising determining a temperature change rate (ΔT) within the cooking chamber during operation.

6. The method for controlling a cooking temperature within a cooking appliance as set forth in claim 5, wherein reducing the initial power (Pᵢ) comprises adjusting the power of the heating element based on the temperature change rate as the cooking chamber temperature approaches the desired cooking temperature.

7. The method for controlling a cooking temperature within a cooking appliance, as set forth in claim 1, further comprising periodically determining a temperature ratio of the desired cooking temperature (T) to an actual cooking chamber temperature (Tₐ).

8. The method for controlling a cooking temperature within a cooking appliance, as set forth in claim 7, wherein maintaining the desired temperature comprises adjusting the reduced power (Pᵣ) to an adjusted power (Pₐ) when the temperature ratio (T:Tₐ) is less than or greater than 1.

9. The method for controlling a cooking temperature within a cooking appliance, as set forth in claim 8, wherein the adjusted power (Pₐ) is less than the reduced power (Pᵣ) when the temperature ratio (T:Tₐ) is greater than one.

10. The method for controlling a cooking temperature within a cooking appliance, as set forth in claim 8, wherein the adjusted power (Pₐ) is greater than the reduced power (Pᵣ) when the temperature ratio (T:Tₐ) is less than one.

11. The method for controlling a cooking temperature within a cooking appliance as set forth in claim 3, wherein the adjusted power (Pₐ) is different than the initial power (Pᵢ).

12. The method for controlling a cooking temperature within a cooking appliance as set forth in claim 3, wherein powering the heating element at the adjusted power (Pₐ) uses an on/off cycle of N milliseconds based on the formulas:
on time=(Pₐ)·N milliseconds; and
off time=(100−Pₐ)·N milliseconds.

13. The method for controlling a cooking temperature within a cooking appliance as set forth in claim 3, wherein adjusting the power is automatic.

14. The method for controlling a cooking temperature within a cooking appliance as set forth in claim 12, wherein the on time in each N millisecond cycle is divided into two periods.

15. The method for controlling a cooking temperature within a cooking appliance as set forth in claim 14, wherein the off time in each N millisecond cycle is divided into two periods.

16. A method for controlling a cooking temperature within a cooking appliance, the cooking appliance comprising a cooking chamber, a heating element for heating the cooking chamber, a temperature setting input, and a controller responsive to the temperature setting input and coupled to the heating element, the method comprising:
setting a desired cooking temperature (T) for the cooking appliance via the temperature setting input;
operating the heating element to heat the cooking chamber based on a power input strategy;
wherein the power input strategy comprises:
selecting an initial power (Pᵢ) between 10% and 100% power, inclusive, based on the desired cooking temperature;
powering the heating element at the initial power (Pᵢ);
determining a temperature change rate (ΔT) within the cooking chamber during operation;
adjusting the initial power to an adjusted power (Pₐ) of the heating element to between 1% and 100% power, inclusive, based on the temperature change rate as the cooking chamber temperature varies from the desired cooking temperature; and
powering the heating element at the adjusted power (Pₐ).

17. The method for controlling a cooking temperature within a cooking appliance as set forth in claim 16, wherein the adjusted power is less than the initial power when the temperature change rate is greater than 10°/min.

18. The method for controlling a cooking temperature within a cooking appliance as set forth in claim 16, wherein the adjust power is greater than the initial power when the temperature change rate is less than 5°/min and the cooking chamber temperature is less than the desired cooking temperature.

19. The method for controlling a cooking temperature within a cooking appliance as set forth

16. 16, wherein powering the heating element at the initial power (Pᵢ) uses an on/off cycle of N milliseconds based on the formulas:
on time=(Pᵢ)·N milliseconds; and
off time=(100−Pᵢ) N milliseconds.

20. The method for controlling a cooking temperature within a cooking appliance as set forth in claim 16, wherein powering the heating element at the adjusted power (Pₐ) uses an on/off cycle of N milliseconds based on the formulas:
on time=(Pₐ)·N milliseconds; and
off time=(100−Pₐ)·N milliseconds.

21. The method for controlling a cooking temperature within a cooking appliance as set forth in claim 16, wherein adjusting the power is automatic.

22. The method for controlling a cooking temperature within a cooking appliance as set forth in claim 21, wherein automatic adjusting of the power setting occurs before the desired cooking temperature is achieved.

23. The method for controlling a cooking temperature within a cooking appliance as set forth in claim 19, wherein the on time in each N millisecond cycle is divided into two periods.

24. The method for controlling a cooking temperature within a cooking appliance as set forth in claim 20, wherein the off time in each N millisecond cycle is divided into two periods.

25. The method for controlling a cooking temperature within a cooking appliance as set forth in claim 16, wherein adjusting the power to the heating element is continuous after the desired cooking temperature is achieved.

26. A method for controlling a cooking temperature within a cooking appliance, the cooking appliance comprising a cooking chamber, a heating element for heating the cooking chamber, a temperature setting input, and a controller responsive to the temperature setting input and coupled to the heating element, the method comprising:
setting a desired cooking temperature (T) for the cooking appliance via the temperature setting input;
operating the heating element to raise an internal temperature within the cooking chamber based on a power input strategy;
wherein the power input strategy comprises:
selecting an initial power (Pᵢ) between 10% and 100% power, inclusive, based on the desired cooking temperature;
powering the heating element at the initial power;
periodically determining a temperature ratio of the desired cooking temperature (T) to an actual cooking chamber temperature (Tₐ)
reducing the initial power to a reduced power (Pᵣ) as the temperature ratio approaches 1:1, wherein the reduced power (Pᵣ) is between 1% and 99% power;
maintaining the desired temperature within the cooking chamber.

27. The method for controlling a cooking temperature within a cooking appliance, as set forth in claim 26, further comprising adjusting the reduced power (Pᵣ) to an adjusted power (Pₐ) within the range of 1% to 100% power.

28. The method for controlling a cooking temperature within a cooking appliance, as set forth in claim 26, wherein maintaining the desired temperature comprises continually adjusting power within the range of 1% to 100% power based on the temperature ratio.

29. The method for controlling a cooking temperature within a cooking appliance, as set forth in claim 26, wherein maintaining the desired temperature comprises adjusting the reduced power (Pᵣ) to an adjusted power (Pₐ) when the temperature ratio (T:Tₐ) is less than or greater than 1.

30. The method for controlling a cooking temperature within a cooking appliance, as set forth in claim 29, wherein the adjusted power (Pₐ) is less than the reduced power (Pᵣ) when the temperature ratio (T:Tₐ) is greater than one.

31. The method for controlling a cooking temperature within a cooking appliance, as set forth in claim 30, wherein the adjusted power (Pₐ) is greater than the reduced power (Pᵣ) when the temperature ratio (T:Tₐ) is less than one.
